(19) United States
(12) Patent Application Publication
(10) Pub. No.: US 2011/0315523 A1
(43) Pub. Date: Dec. 29, 2011

(54) BAGGAGE HANDLING SYSTEM

(75) Inventors: Kok Leng LIM, Singapore (SG); Hee Kwee SNG, Singapore (SG)

(73) Assignee: PTERIS GLOBAL LIMITED, Singapore (SG)

(21) Appl. No.: 13/169,066

(22) Filed: Jun. 27, 2011

Related U.S. Application Data
(60) Provisional application No. 61/358,941, filed on Jun. 28, 2010.
(60) Provisional application No. 61/453,979, filed on Mar. 18, 2011.

(51) Int. Cl. B65G 23/04

(52) U.S. Cl. 198/835

(57) ABSTRACT

A junction conveyor which facilitates transferring of articles from one conveyor to another conveyor is disclosed. The junction conveyor includes a conveyor frame and a pulley arrangement having a plurality of pulleys being mounted onto the frame. The pulley arrangement includes at least a first and a second pulley defining a first and a second end of the junction conveyor. The pulley arrangement also includes at least one free rolling pulley and a drive pulley. The junction conveyor further includes a belt being fitted to the pulley arrangement to form a junction conveying surface of the junction conveyor.

### CROSS REFERENCE TO RELATED APPLICATIONS

This application is a Non-Provisional Application which claims the benefit of U.S. Provisional Application Ser. No. 61/358,941, filed on Jun. 28, 2010 and U.S. Provisional Application Ser. No. 61/453,979, filed on Mar. 18, 2011, the disclosures of which are incorporated herewith by reference in their entirety.

### BACKGROUND

A junction conveyor facilitates transferring of articles from one conveyor to another conveyor. The junction conveyor is implemented to transfer articles in one direction (uni-directional). For example, the junction conveyor can be employed to transfer articles from a first conveyor to a second conveyor.

However, conventional junction conveyor generates high amount of heat due to friction, which eventually leads to belt expansion, elongation and alignment problems. As such, the efficiency of conventional junction conveyor is relatively low due to high friction and a more powerful motor is required to drive the junction conveyor. Furthermore, maintenance and replacement of the belt of the conventional junction conveyor are relatively difficult and complex.

From the foregoing discussion, it is desirable to provide a junction conveyor with improved efficiency and reliability.

### SUMMARY

Embodiments relate generally to conveyor system. In one embodiment, a junction conveyor is disclosed. The junction conveyor includes a conveyor frame and a pulley arrangement having a plurality of pulleys mounted onto the frame. The pulley arrangement includes at least a first and a second end pulley defining a first and a second end of the junction conveyor, at least one of the pulleys includes a free rolling pulley, and a drive pulley for driving a belt to cause a junction conveyor surface to move in a desired direction. The junction conveyor further includes a belt being fitted to the pulley arrangement to form a junction conveyor surface.

In another embodiment, a conveyor system is disclosed. The conveyor system includes first and second conveyor and a junction conveyor. The junction conveyor includes a conveyor frame and a pulley arrangement having a plurality of pulleys being mounted onto the frame. The pulley arrangement includes at least a first and a second end pulley defining a first and a second end of the junction conveyor, at least one of the pulleys includes a free rolling pulley, and a drive pulley for driving a belt to cause a junction conveyor surface to move in a desired direction. The junction conveyor further includes a belt being fitted to the pulley arrangement to form a junction conveyor surface. The junction conveyor is disposed between the first and second conveyors and the first conveyor is disposed at an angle θ₁ with respect to the second conveyor.

These and other objects, along with advantages and features of the invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows an embodiment of a portion of a conveyor system;

FIG. 2 shows an embodiment of a junction conveyor;

FIGS. 3a-c show various views of an embodiment of a pulley arrangement;

FIG. 4 shows an embodiment of a crown pulley;

FIG. 5 shows an embodiment of a nose pulley;

FIG. 6a-b show an embodiment of an arrangement of nose pulleys with mounting members;

FIG. 7 shows an embodiment of a slider bed arrangement;

FIGS. 8a-b show various embodiments of engagement of a slider bed arrangement with a tail pulley or an upper nose pulley;

FIGS. 9a-e show various views of another embodiment of a junction conveyor;

FIGS. 10a-d show various views of another embodiment of a pulley arrangement;

FIGS. 11a-d show various views of yet another embodiment of a pulley arrangement;

FIGS. 12a-b show various views of an embodiment of a bend pulley or a drive pulley;

FIGS. 13a-b show various views of an embodiment of a belt of a junction conveyor;

FIG. 14 shows another embodiment of a nose pulley; and

FIGS. 15a-b shows various embodiments of a stop plate.

### DETAILED DESCRIPTION

Embodiments generally relate to conveyor systems. In particular, embodiments relate to a junction conveyor for merging two conveyors of a conveying system. The conveying system, for example, may be employed to transport baggage as part of an airport baggage handling system. In other embodiments, the conveying system may be employed to transport other types of packages or articles.

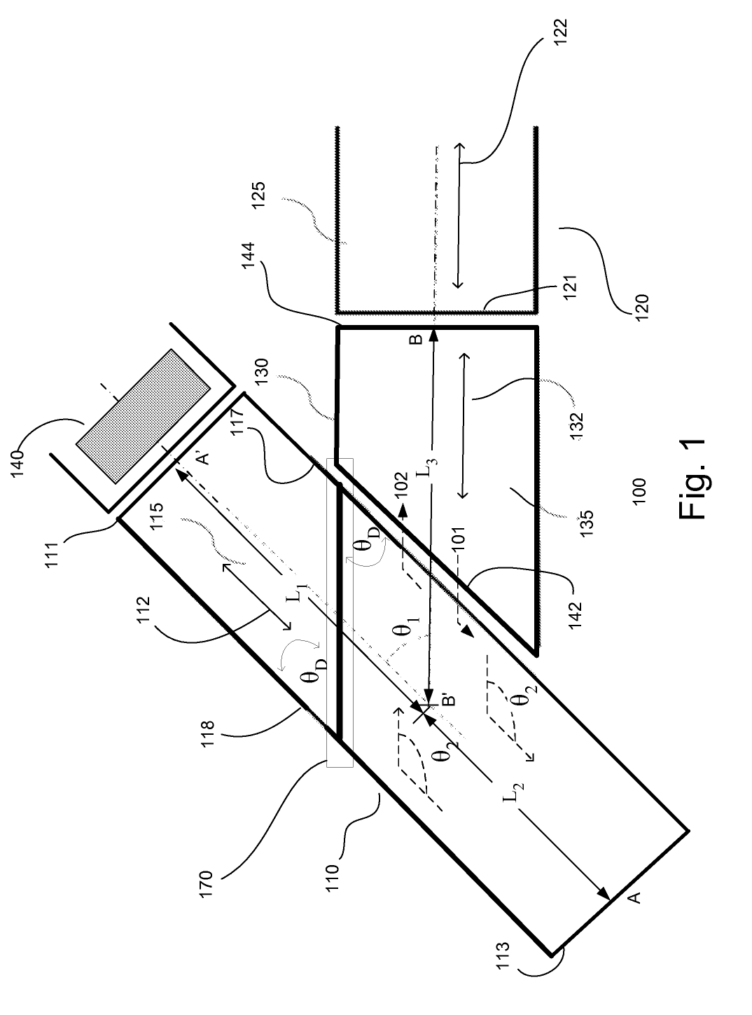

FIG. 1 shows an embodiment of a portion of a conveying system 100. As shown, the conveying system includes first and second conveyors 110 and 120. The first conveyor includes a first conveying surface 115; the second conveyor includes a second conveying surface 125. The first conveying surface 115, in one embodiment, is a smooth surface which facilitates the change of article's orientation during the transfer of articles as indicated by arrow 101 or 102. The conveying system may include more than two conveyors. For example, a third conveyor 140 may be provided adjacent to the first conveyor. Providing additional conveyor at other location may also be useful.

A conveyor, for example, includes at least first and second end pulleys or rollers mounted on a conveyor frame. A belt is fitted on the pulleys to form the conveying surface. The belt, for example, may include an endless belt, a lacing belt or a zip belt. Other types of belts may also be used. Depending on the length of the conveyor, one or more intermediate rollers may be disposed between the end rollers to provide support for the conveying surface. One of the pulleys of the conveyor is coupled to a motor and serves as a drive pulley for rotating the belt to transport articles thereon. The motor which drives the drive pulley, in one embodiment, includes an electrical brake mechanism (not shown). In one embodiment, the start or stop control of the motor is coupled to an inverter (not shown). The inverter can be used to vary the speed of the conveyor depending on applications. For example, to stop the operation of the conveyor, an electrical brake is applied through the inverter. The use of an electrical brake is advantageous since it reduces heat generation. Such control configuration of the motor increases product life cycle of the conveyor system. Other types of brake mechanisms, such as a mechanical brake mechanism, may also be useful. For a straight conveyor, the end pulleys are mounted to the conveyor belt and are arranged along a direction which is perpendicular to the direction of travel, for example, as indicated by arrows 112 and 122. An outer end of the end pulleys form end surfaces of the conveyor.

The first and second conveyors are arranged at an angle θ₁ with respect to each other. The angle θ₁, for example, is the smallest angle with respect to the first and second conveyors. The angle θ₁ may be, for example, about 30-60°. In one embodiment, θ₁ may be about 45°. Providing other angles for θ₁ may also be useful. The angle θ₁ should facilitate transfer of articles from the first conveyor to the second conveyor or vice-versa.

The second conveyor includes a first end 121 and a second end (not shown). The first end is proximate to the first conveyor while the second end is distal from the first conveyor. The first and second ends form first and second end surfaces of the second conveyor. In one embodiment, the end surfaces of the conveyor are perpendicular to a direction of travel of the conveyor, as indicated by arrow 122. Providing end surfaces of the conveyor which have other angles may also be useful.

As discussed, the first conveyor 110 is disposed at an angle θ₁ with respect to the second conveyor. The first conveyor, for example, includes a center axis A-A′ that is parallel with the direction of travel of the first conveyor, as indicated by arrow 112. The first conveyor also includes first end 111 and second end 113. The first and second ends may form end surfaces which are perpendicular to the direction of travel of the conveyor 110, as indicated by arrow 112. The first conveyor includes first and second sides 117 and 118. The first side is proximate to the first end of the second conveyor 120 while the second side is distal from the first end of the second conveyor. The first side of the first conveyor and the first end surface of the second conveyor form the angle θ₁. With respect to the direction of travel of the article, the conveyors are disposed at an angle θ₂, which is a supplemental angle of θ₁.

A junction conveyor 130 is disposed between the first and second conveyors. The junction conveyor facilitates transfer of articles from the first to the second conveyor or from the second to the first conveyor. In one embodiment, the junction conveyor can facilitate transfer of articles from the first conveyor to the second conveyor as well as the second to the first conveyor, resulting in a bi-directional junction conveyor. For example, direction of transfer can be changed by reversing the direction of belt travel. In some cases, the pulley arrangement may be reconfigured to accommodate direction change.

The junction conveyor includes a center axis B-B′ that is parallel with the direction of travel of the junction conveyor, as indicated by arrow 132. The junction conveyor also includes first and second ends 142 and 144. The first end is disposed adjacent to the first conveyor and the second end is disposed adjacent to the second conveyor. In one embodiment, the first end forms an angle θ₁ with respect to the direction of travel of the junction conveyor. As for the second end, it is perpendicular to the direction of travel 132 of the junction conveyor. The first end 142 may be referred to as the “diverge” or “merge” end while the second end 144 may be referred to as the “branch” end. The ends are arranged to juxtapose with the first side surface 117 of the first conveyor and first end surface 121 of the second conveyor. In one embodiment, the ends are arranged to juxtapose with the first side surface of the first conveyor and first end surface of the second conveyor without contacting the first side surface of the first conveyor and first end surface of the second conveyor.

The first conveyor includes a length L_{T}. The length L_{T} includes a first length L₁ and a second length L₂. L₁ and L₂, for example, correspond to first and second portions of the first conveyor. L₁ is measured along the center axis A-A′ from the first end 111 to the second portion and L₂ is measured from the second portion to the second end 113 of the conveyor. The conveyor system also includes a third length L₃, which is measured along the center axis B-B′ that is parallel with the direction of travel of the junction conveyor 132 from the second end 144 of the junction conveyor to the intersection of the center axis A-A′ of the first conveyor, which also is the interface of the first and second portions of the first conveyor.

In one embodiment, the first conveyor and the junction conveyor is arranged such that the first length L₁ of the first conveyor is the same as a third length L₃. Such arrangement provides a better control of transfer of articles. The first conveyor and the junction conveyor may also be arranged in different configurations. In one embodiment, the length L₂ is sufficient to at least accommodate an article. For example, L₂ is sufficient to at least accommodate the maximum designed length of an article transferred by the conveyor system. Other lengths may also be useful.

A belt is fitted to a pulley arrangement having plurality of pulleys to form the junction conveyor surface 135. The belt, for example, may include an endless belt, a lace belt or a zip belt. Other types of belts may also be used. The belt may optionally include a belt fitting surface such as a protrusion and one or more pulleys may optionally include pulley fitting surface such as a step profile. The pulley arrangement forms the ends of the junction conveyor, as desired. For example, at least one first end pulley and at least one second end pulley are used to form the first and second ends of the junction conveyor. The first end pulley may be referred to as a nose pulley and the second end pulley may be referred to as a tail pulley. In addition, a drive pulley is provided to drive the belt to cause the junction conveyor surface to move in a first or second direction, as desired. Additional pulleys may be provided in the pulley arrangement on which the belt is fitted.

As discussed, articles can be transferred from the first to the second or from the second to the first conveyor, as indicated by arrows 102 or 101, respectively. The angle formed by the transfer from one conveyor to the other, in one embodiment, is equal to θ₂. For example, the angle θ₂ is the larger of the supplemental angles formed by the conveyors.

For the case in which articles are transferred from the first conveyor to the second conveyor, as indicated by arrow 102, a diverter system 170 may be employed to divert the article from the first conveyor to the second conveyor via the junction conveyor. The diverter system, for example, may include first and second diverter arms which swing form the sides in a non-actuated position to across the conveyor surface when actuated. The diverter arms may form an angle θ_{D} with respect to the sides of the conveyor or direction of travel. In one embodiment, θ_{D} may be about θ₁. For example, θ_{D} may be about 45°. Other angles which facilitate transfer of articles from the first conveyor to the second conveyor may also be useful. Such diverter system, for example, is described in co-pending U.S. patent application Ser. No. 12/537,234, titled High Speed Diverter, which is herein incorporated by reference for all purposes. Other types of diverter systems may also be employed.

As for the case in which articles are transferred from the second to the first conveyor, as indicated by arrow 101, a diverter system is not necessary.

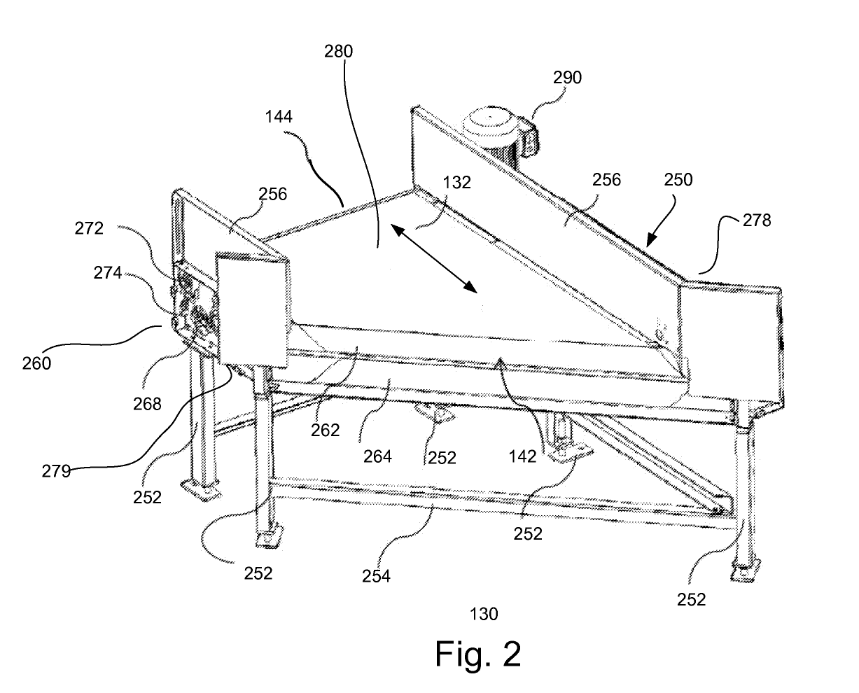

FIG. 2 shows one embodiment of a junction conveyor 130. The conveyor system includes a conveyor frame 250. The conveyor frame, as shown, is mounted on a plurality of frame legs 252. Mounts can be provided at the end of the legs for fixing the conveyor in position. Cross braces 254 may interconnect the legs to provide structural support. The frame, legs and braces may be formed from metal. The frame, for example, should be able to withstand a weight of at least about 390 kg. Other types of material which has sufficient mechanical stability, for example, as required by design requirements, may also be employed. For example, materials, such as JIS SS400 mild steel, AISI 1040 mild steel, aluminum profile 6061, ASTM A283 steel grade D may also be used. Other materials may also be useful, depending on the design and weight requirements.

The legs may be provided to set the conveyor system to the desired height. For example, the height of the conveyor surface may set to be equal with the conveying surfaces of the first and second conveyor. For example, the first end of the conveyor surface of the junction conveyor may be equal to the height of the conveyor surface of the first conveyor and the second end of the conveyor surface of the junction conveyor may be equal to the height of the conveyor surface of the second conveyor. It is understood that the heights of the first and second end need not be equal to form a sloping conveyor surface. In one embodiment, the leg mounts may comprise height adjustable leg mounts to adjust the height of the junction conveyor, facilitating height alignment with adjacent conveyors of the conveyor system.

A pulley arrangement 260 is mounted onto the frame. The pulley arrangement includes a plurality of pulleys. The pulley arrangement defines the shape of the conveying surface. For example, the pulley arrangement includes nose pulleys 262 and 264 located at a first end 142 and a tail pulley 272 and a take up pulley 274 at a second end 144. The nose pulleys in one embodiment, defines the angle of the conveying surface with respect to the first conveyor. Additional pulleys, such as bend pulley 278, drive pulley 268 and return pulley 279 may also be provided. A pulley, for example, includes a drum with end plates having a shaft. The drum portion contacts the belt while the end plates are attached to the ends of the drum. Other types of conveyor pulleys, such as crown pulley and tapered pulley, may also be used. In one embodiment, to mount a pulley to the frame, sole plates with flange mount bearings are used. The shafts are mated to the inner face of the bearing to allow the pulley to freely rotate. Alignment of the pulley is facilitated by the sole plates.

A belt 280 is fitted onto the pulley arrangement to form the conveyor surface. The belt, for example, is a conveyor belt which forms a loop. The belt, for example, may include an endless belt, a lace belt or a zip belt. Other types of belts may also be used. The belt includes opposing major surfaces. One of the major surfaces is rough while the other is smooth. Other types of belts may also be used. In one embodiment, the belt is fitted to the pulley arrangement to result in the rough surface to form the conveyor surface. The rough surface is advantageous to provide increased friction with the article to be transported. This avoids or reduces slippage of the article as it is transported by the conveyor.

The drive pulley is coupled to a motor 290 for rotating the drive pulley to cause the conveyor surface to move. In one embodiment, the motor is a three-phase motor, such as an AC gear motor. The motor, for example, is sufficient to move the conveyor surface at about 3.34-3.5 msec. Providing a motor capable of driving the conveyor at other velocities is also useful. Depending on the direction of rotation, the conveyor surface moves in a first or a second direction along the direction of travel, as indicated by arrow 132. In one embodiment, the pulley arrangement results in the rough surface of the belt contacting the surface of the drive pulley. This avoids or reduces slippage of the belt as the drive pulley is rotating, facilitating faster rotations or greater belt velocity. In one embodiment, the motor includes an electrical brake mechanism (not shown) as described previously. Other types of brake mechanisms may also be useful.

In one embodiment, the pulleys of the pulley arrangement, except for the drive pulleys, are free rolling pulleys, including the nose pulleys. The pulleys are configured to maintain or guide the belt on path in the pulley arrangement without the need to have the nose pulleys fixed or non-rotating. Providing free rolling pulleys, including the nose pulleys, reduces friction. This enables high speed operation with reduced power consumption. For example, reduced power consumption of about 25% may be achieved over conventional junction conveyors. As such, motor with lower power and smaller size can be employed in the conveyor system. This leads to a smaller, lighter and more compact conveyor system. Furthermore, increased reliability is achieved. For example, reduced heat generation results as well as increase life span of consumable parts of the junction conveyor, such as nose pulleys, belt and motor.

In other embodiments, the pulley arrangement may include fixed or non-rotating pulleys. For example, one or more of the nose pulleys maybe configured to be fixed pulleys. In one embodiment, the nose pulley or nose pulleys are fixed pulleys. Alternatively, at least one of the nose pulleys is configured to be a fixed pulley. Side guards 256 are mounted to the frame along the direction of travel. The side guards prevent articles on the conveyor surface from falling off the sides of the conveyor.

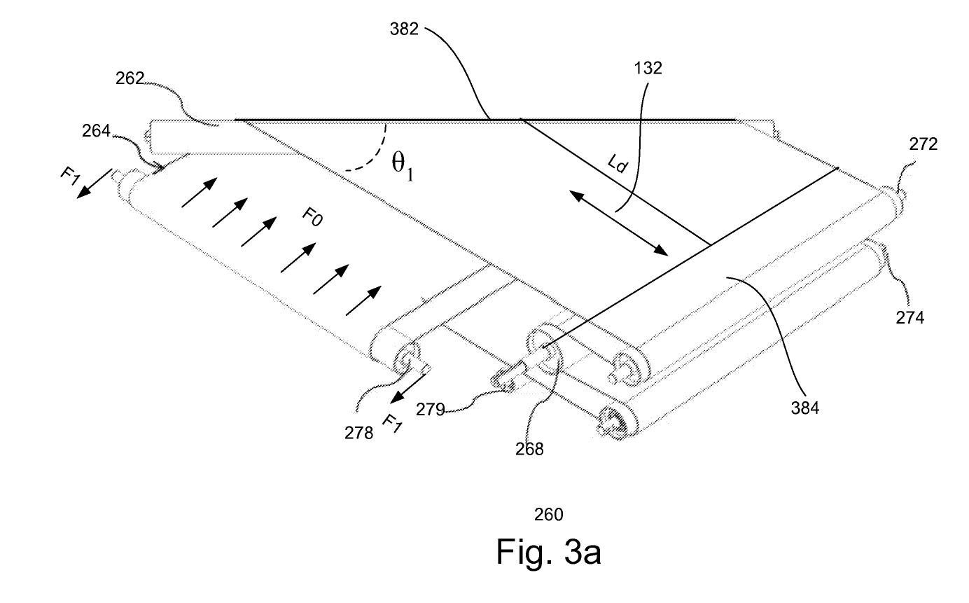

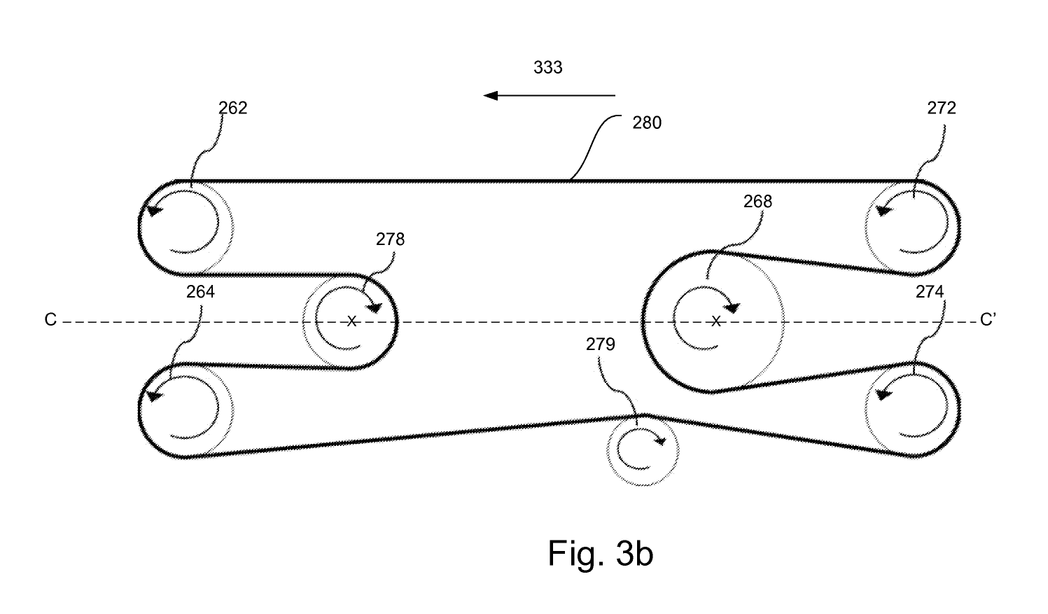

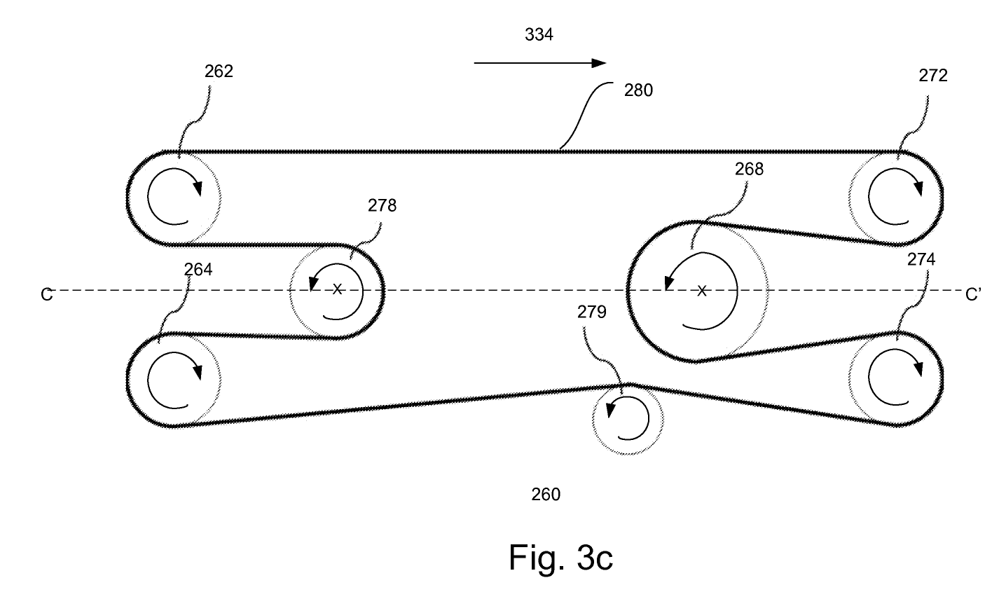

FIG. 3a shows a dimensional view of an embodiment of a pulley arrangement 260 with a belt 280 while FIGS. 3b-c show simplified views of the pulley arrangement with the belt. As shown, the pulley arrangement includes a plurality of pulleys. At a first end 382 of the pulley arrangement, which corresponds to the first or nose end of the junction conveyor, a nose pulley is provided. In one embodiment, first and second nose pulleys 262 and 264, are provided. The nose pulleys are disposed at an angle θ₁ with respect to the direction of travel of the belt, as indicated by arrow 132. The angle θ₁, as discussed, may range from about 30-60°. In one embodiment, the angle θ₁ is about 45°. Arranging the nose pulleys at other angles may also be useful. The first and second nose pulleys include a length to accommodate the belt which fits thereover. The length of the nose pulley may vary, depending on the angle θ₁. For example, the length of the nose pulley for 30° with respect to direction of travel may be longer than the length of the nose pulley for 45°. In one embodiment, the length of the nose pulley is at least equal to width of the conveyor/sine θ₁. The first nose pulley is disposed above the second nose pulley, forming upper and lower nose pulleys. In one embodiment, the nose pulleys are vertically (or in a direction perpendicular to the plane of the conveyor surface) aligned. Providing other configurations of the nose pulleys may also be useful. For example, the lower nose pulley may be recessed from the edge of the first end.

A tail pulley 272 and take up pulley 274 are disposed on a second end 384 of the pulley arrangement, which corresponds to the branch end of the junction conveyor. In one embodiment, the tail and take up pulley are disposed perpendicularly with respect to the direction of travel. In one embodiment, the tail and take up pulleys are vertically (or in a direction perpendicular to the plane of the conveyor surface) aligned. Providing other configurations of the tail and take up pulleys may also be useful. For example, providing the take up pulley which is recessed from the edge of the second end may also be useful.

A drive pulley 268 is disposed perpendicularly with respect to the direction of travel. In one embodiment, the drive pulley is disposed near the second end of the pulley arrangement. The drive pulley is located between the tail and take up pulley and recessed from the second end. The drive pulley, in one embodiment, is located a distance away from the second end and have a belt wrapping angle of at least 200° around it. Such arrangement of the drive pulley reduces belt slippage and provides better efficiency for driving the belt. Other configurations of the drive pulley may also be useful. A motor is coupled to the drive pulley. When the motor rotates the drive pulley, the conveyor surface is moved. For example, the conveyor surface moves in a first direction, as indicated by arrow 333 when the drive pulley rotates in a clockwise direction. When the drive motor rotates in a counter-clockwise direction, the conveyor surface is moved in a second direction, as indicated by arrow 334.

A bend pulley 278 is disposed in parallel with respect to the direction of travel from a first end of the pulley arrangement. The bend pulley, for example, is disposed on a side which is longer along the direction of travel and forms an angle θ₁ with respect the nose pulleys. The angle θ₁, as discussed may range from about 30-60°. In one embodiment, the angle θ₁ is about 45°. Arranging the bend pulley at other angles with respect to the nose pulleys may also be useful. As shown, a first end of the bend pulley is adjacent to first ends of the nose pulleys. A second end of the bend pulley is distal from the first ends of the nose pulleys. In one embodiment, the bend pulley is located between the nose pulleys.

The arrangement of the drive pulley and bend pulley with respect to the direction of travel as described above provide several advantages. For example, when the drive pulley is disposed perpendicularly with respect to the direction of travel 132, a longer distance Ld between the nose pulleys and the drive pulley is obtained as shown in FIG. 3a. This creates lesser belt tension force and therefore lesser effort is required by the bend pulley for adjusting the belt tension. In addition, the arrangement of the bend pulley in parallel with the direction of travel enables the adjustment of belt tension to be easily performed relative to if a drive pulley were to be arranged at this position. This is because the bend pulley is not obstructed by other components of the junction conveyor, such as the motor or gear box compartments. In addition, the equilibrium of the center alignment of the belt is achieved based on the forces resulted from the configurations of the pulleys and bearings. For example, the force F0 and F1 of the bend pulley, as shown in FIG. 3a, should satisfy the following equation:

F0=2F1;

where F0 is the tension force upon the pulley by the belt an F1 is the force upon the bearing. To achieve equilibrium for center alignment of belt, one pulley, for example, the bend pulley, which is parallel to the direction of travel and one pulley, for example, the take up pulley, which is perpendicular to the direction of travel are chosen to be mechanically adjustable for the belt tensioning in the pulley arrangement. Other pulleys may also be chosen so long as it fulfills the criteria as described above to achieve equilibrium for center alignment of the belt.

As shown, the upper nose pulley and tail pulley form an upper pulley level of the pulley arrangement and defines the conveying. The lower nose pulley and take up pulley form a lower pulley level of the pulley arrangement. The bend pulley and drive pulley are disposed in an intermediate pulley level between the upper and lower pulley levels. A return pulley 279 is disposed below the lower pulley level. As shown, the axes of rotation of the pulleys within a pulley level form parallel planes. Providing pulleys of different pulley levels which do not form parallel planes may also be useful.

In one embodiment, the axes of rotation of the bend pulley and the drive pulley form a plane CC′ as shown in FIGS. 3b-c. The pulleys above and the pulleys below the plane CC′ are arranged substantially symmetrical to each other. For example, the pulleys on the upper pulley level are symmetrical or substantially symmetrical to the pulleys on the lower pulley level. The symmetry of the pulley configurations along the plane CC′ enables forces acting on both directions (e.g., forward and reverse) to be almost equal. Such a configuration enables the junction conveyor to operate bi-directionally.

The pulleys in the pulley system may have the same and/or different diameters. In one embodiment, the take up, tail and nose pulleys have the same drum diameter while the drive pulley has a larger diameter. The return pulley may have a diameter which is smaller than the nose and other pulleys. Other arrangements of pulley diameters may also be useful. The diameter of the drive pulley, for example, is about 140-180 mm. Other dimensions for the diameter of the drive pulley may also be useful. The diameter of the drive pulley may be selected based on the desired speed of the junction conveyor or other design requirements.

The belt fits around the pulleys of the pulley arrangement to form a continuous loop. For example, the belt fits around the upper nose pulley, bend pulley, lower nose pulley, take up pulley, drive pulley, tail pulley and back to the upper nose pulley. The return pulley provides a support for belt sagging. For example, the return pulley can be adjusted in a direction perpendicular to the direction of travel to prevent the belt from sagging. The take up pulley adjusts the tension of the belt around the pulleys. The bend pulley is adjustable for belt to be square during installation. For example, the bend pulley can be adjusted horizontally to counter the forces to ensure that the belt is tracked properly during operation. The lengths of the pulley should be sufficient to accommodate the width of the belts.

In one embodiment, the belt comprises a rough surface and a smooth surface. The arrangement of pulleys should result in the rough surface of the belt forming the conveying surface between the top nose pulley and tail pulley as well as contacting the surface of the drive pulley. This reduces slippage of the articles from the conveying surface and also provides a better driving efficiency. In one embodiment, the pulley arrangement should result in the smooth surface of the belt contacting the surface of the nose pulleys, tail pulley and take up pulley. This advantageously reduces heat generation and increases efficiency.

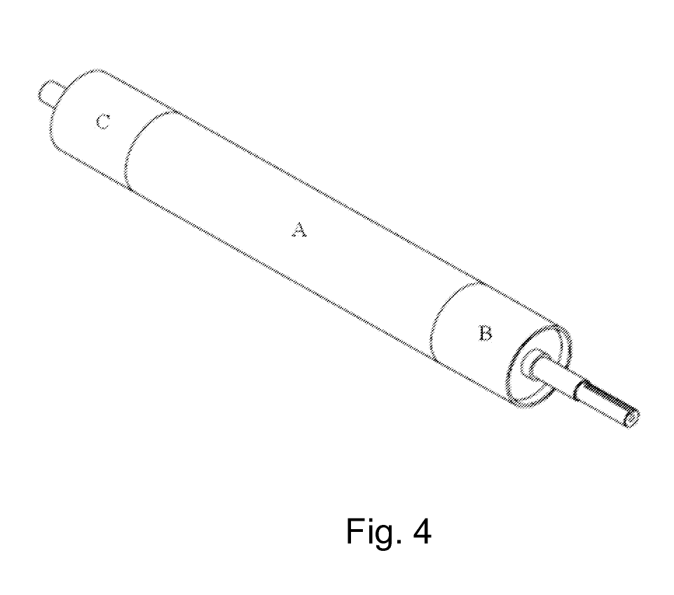

To facilitate tracking and centering of the belt, the pulleys, except for the nose pulleys, tail pulley and return pulley, comprise crown pulleys. Referring to FIG. 4, a crown pulley is a pulley whose diameter is the greatest at a center and tapers to a smallest diameter at the ends. For example, section A of the crown pulley is bigger than two other diameters of sections B and C. The crown pulley, for example, follows the guidelines of ISO 100-1984 (E). The crown pulley, in one embodiment, includes a tapering angle of about 0.36° from both ends of the section A to distal end of section B and C. Providing other tapering angles may also be useful, depending on the length and diameter of the pulley.

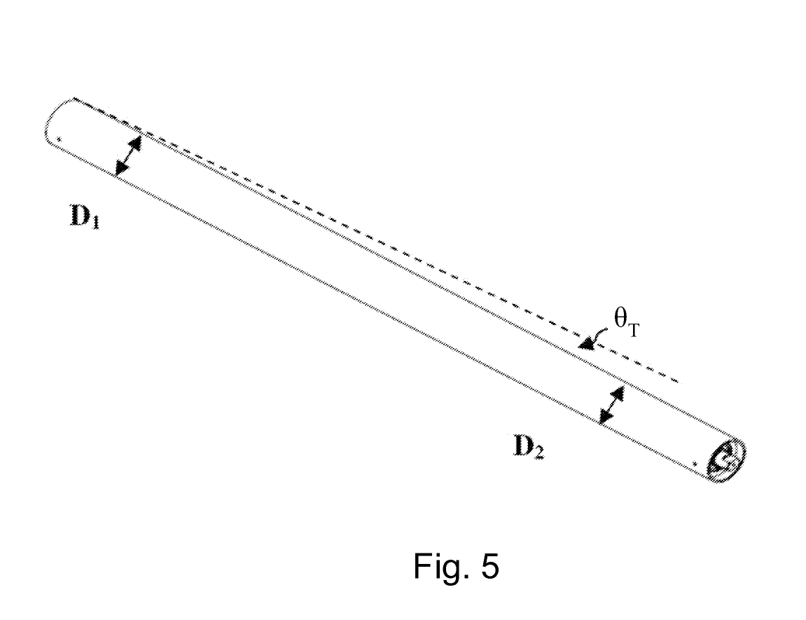

As for the nose pulleys, they comprise tapered pulleys. Referring to FIG. 5, a tapered pulley has the largest diameter in a first end and tapers to the smallest diameter in the second end. For example, the largest diameter is located closer to the shorter conveying surface side while the smallest diameter is closer to the longer conveying surface side of the junction conveyor or closer to the bend pulley. In one embodiment, the tapering angle θ_{T} for the tapered pulley may be about 0.1°. Providing other tapering angles for the tapered pulley may also be useful, depending on the length and diameters of the pulleys. The tapered nose pulleys are arranged in the conveyor to counter the force which causes the belt to shift to one side of the conveyer and to facilitate tracking of the belt on the pulley arrangement. As such, this avoids the use of a belt guide and pulley fitting surface even if one or more pulleys in the pulley arrangement are free rolling pulleys. In addition, the use of crown pulleys and tapered pulleys avoids the use of additional pulleys, such as snub pulleys to facilitate tracking and centering of the belt. This leads to a lighter and more compact conveyor system as well as reduced cost.

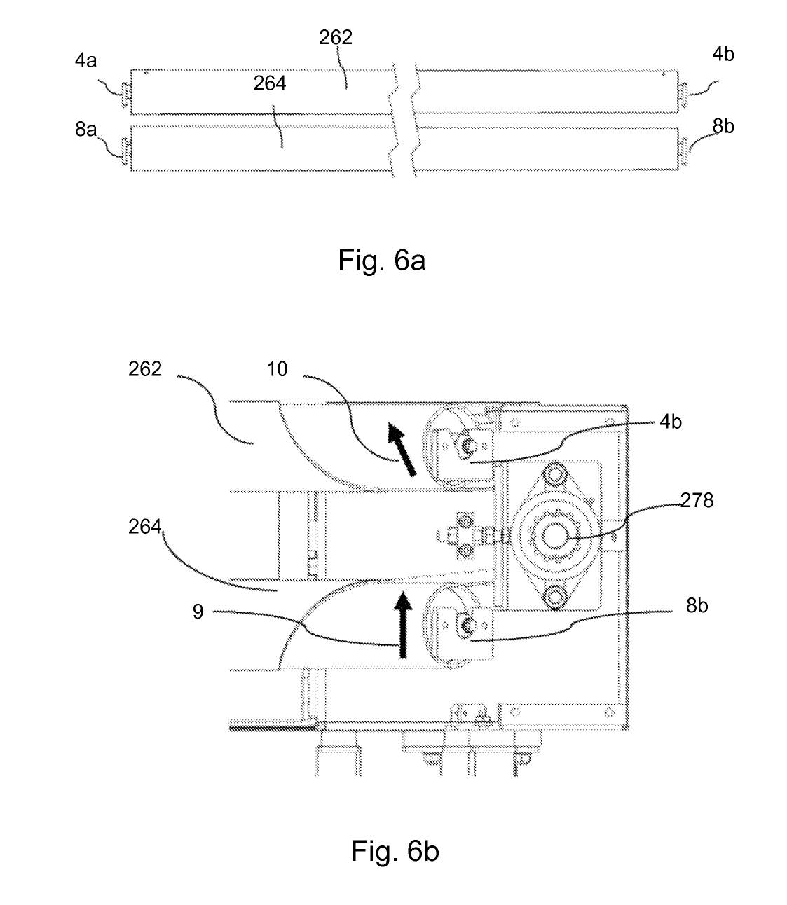

As discussed, the first and second nose pulleys are tapered pulleys. The diameter of the first and second nose pulleys, in one embodiment, is larger than the diameter of conventional nose pulleys. The nose pulleys with larger diameters, for example, enhance heat dissipation. The first nose pulley, for example, is disposed above the second nose pulley, forming upper and lower nose pulleys. The nose pulleys, in one embodiment, are vertically aligned. Referring to FIGS. 6a-b, the first and second nose pulleys are mounted on the frame of the junction conveyor by mounting members. The mounting members, for example, may be mounting brackets. In one embodiment, the first pulley 262 is supported by first and second mounting members 4a and 4b. The first and second members are configured such that the first nose pulley can be removed easily by a first direction, as shown by arrow 10. Similarly, the second nose pulley is supported by third and fourth mounting members 8a and 8b. The second nose pulley may be removed easily by a second direction, as shown by arrow 9.

Each of the mounting members, in one embodiment, includes one slot for engaging the nose pulleys 262 and 264. The slot shape for the first mounting member 4a, for example, is the same as the slot shape of the second mounting member 4b. Similarly, the slot shape for the third and fourth mounting members 8a and 8b is the same. The size of the slots for the first and third mounting members 4a and 8a, in one embodiment, is bigger relative to the size of the slots for the second and fourth mounting members 4b and 8b. As the nose pulleys are tapered pulleys, the difference in slot sizes of the mounting members facilitates installation of the nose pulleys.

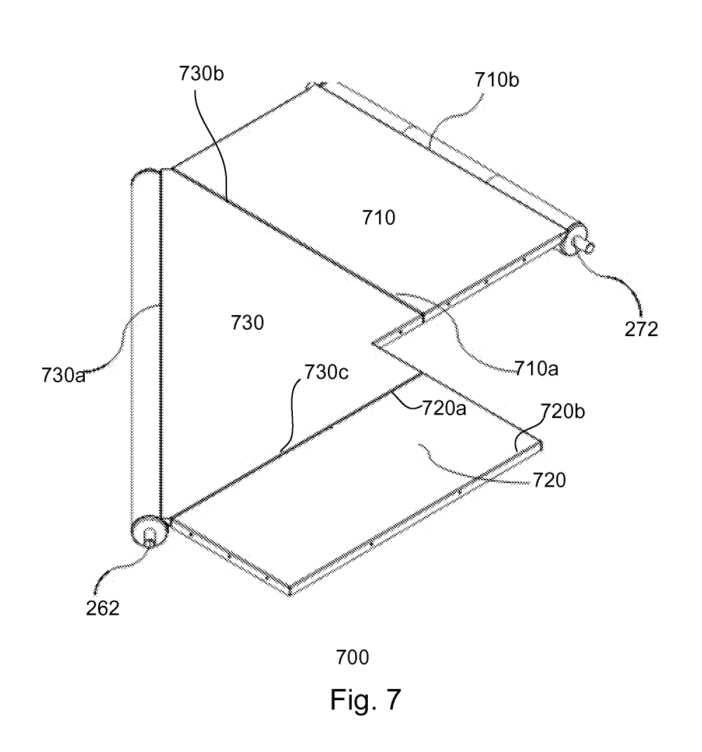

FIG. 7 shows an embodiment of a slider bed structure 700. The slider bed structure, in one embodiment, includes first 710, second 720 and third 730 members. In one embodiment, the first, second and third members are separately formed. The first member 710, for example, includes a first end 710a and a second end 710b. The second member 720, for example, includes a first end 720a and a second end 720b, whereas the third member 730 includes a first end 730a, a second end 730b and a third end 730c. In one embodiment, the second end 730b of the third member is adjacent to the first end 710a of the first member, whereas the third end 730c of the third member is adjacent to the first end 720a of the second member. The first, second and third members, in one embodiment, are connected to each other without welding. For example, the first, second and third members are connected to each other by bolts and nuts. Providing other types of connecting members may also be useful. The slider bed is configured and arranged such that it is easily maintained and replaceable.

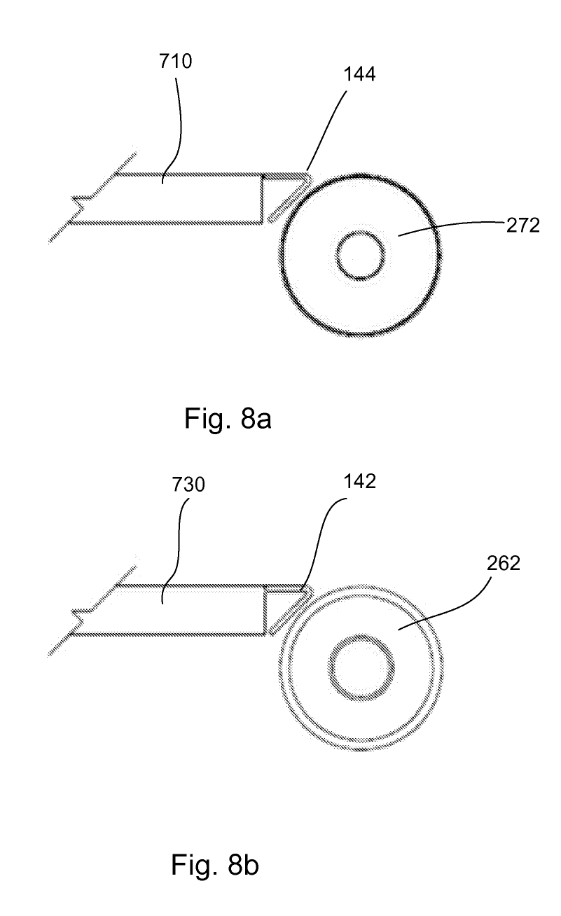

FIGS. 8a-b shows various embodiments of arrangement of the slider bed structure 700. As shown in FIG. 8a, the second end 710b of the first member of the slider bed structure is arranged to be adjacent to the tail pulley 272. Referring to FIG. 8b, the second end 730b of the third member of the slider bed structure is arranged to be adjacent to the first or upper nose pulley 262. These ends of the slider bed structure, in one embodiment, are arranged to be substantially close with the tail pulley or the first nose pulley. For example, the second end of the first member is at about 2-5 mm from the tail pulley whereas the second end of the third member is about 2-5 mm from the first nose pulley. Such arrangement ensures smooth transfer of articles on the conveying surfaces of the conveyor system 100.

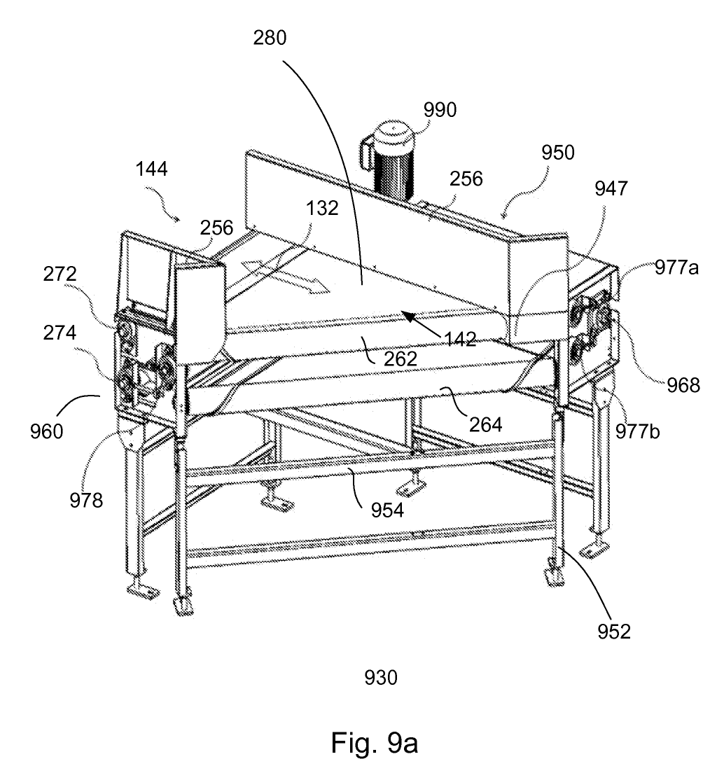

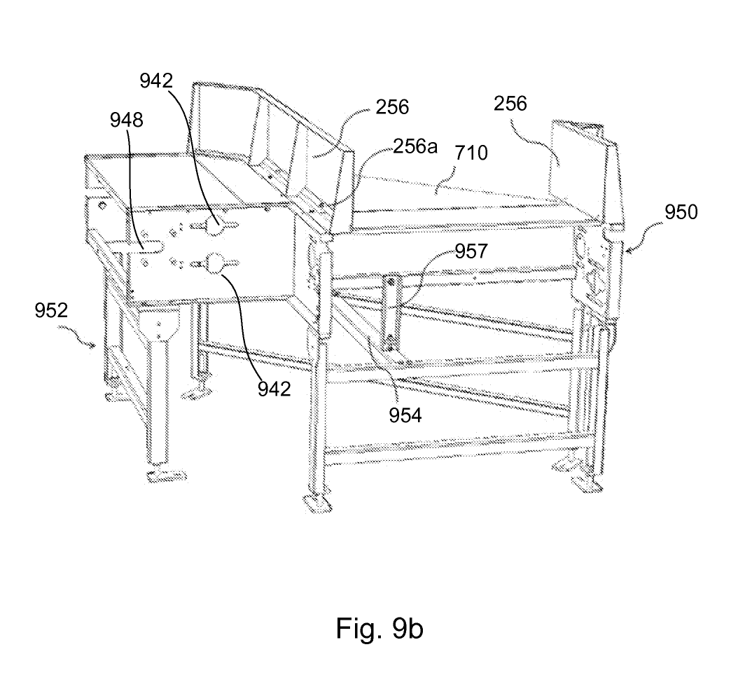

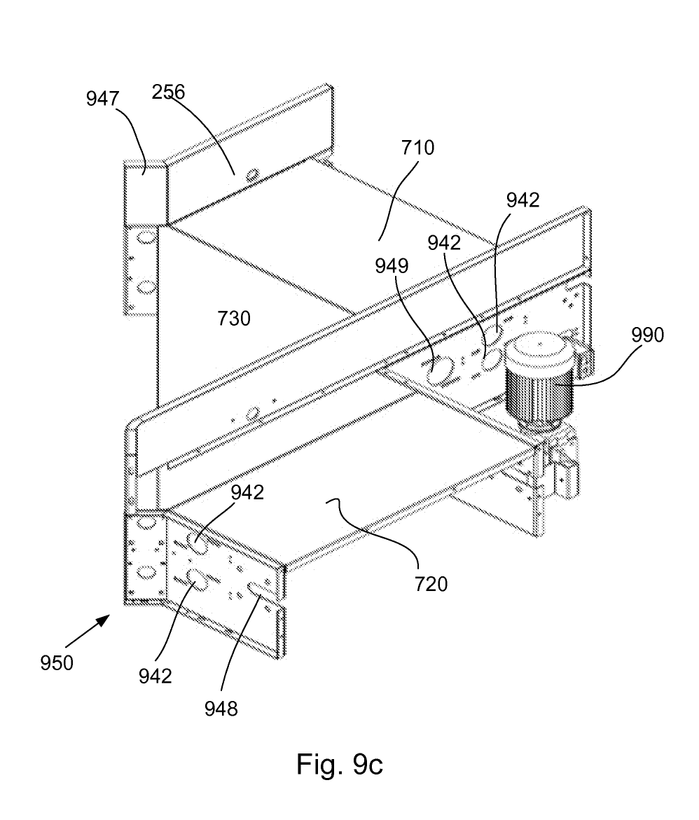

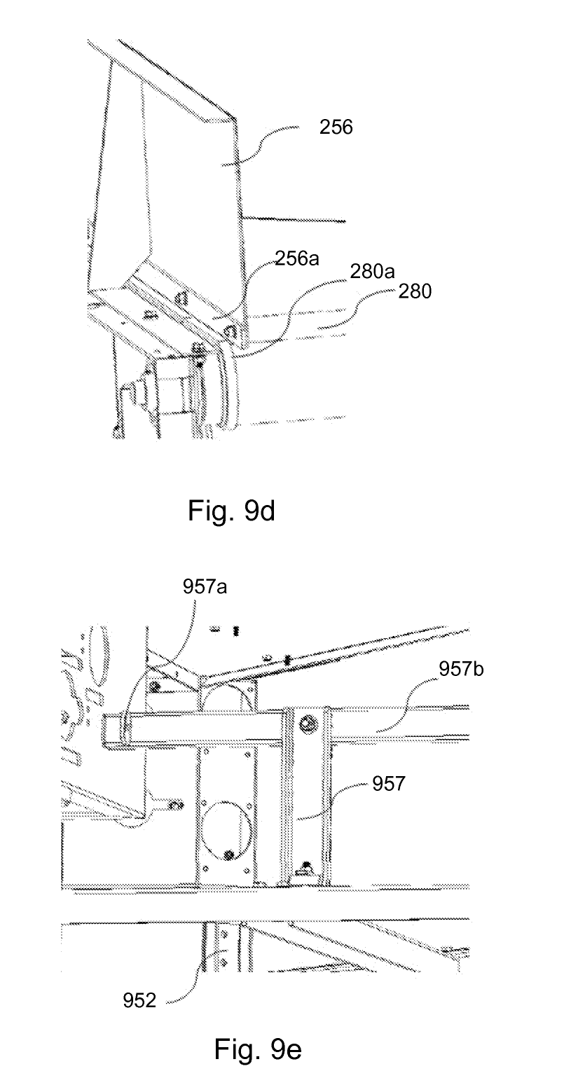

FIGS. 9a-e show various view of another embodiment of a junction conveyor 930. The junction conveyor 930, for example, is similar to that described in FIG. 2. As such, the common features need not be discussed.

The junction conveyor 930 includes a conveyor frame 950. The conveyor frame, as shown, is mounted on a plurality of frame legs 952. Mounts can be provided at the end of the legs for fixing the conveyor in position. Cross braces 954 may interconnect the legs to provide structural support. The frame, legs and braces may be formed from metal. The frame, for example, should be able to withstand a weight of at least about 390 kg. Other types of material which has sufficient mechanical stability, for example, as required by design requirements, may also be employed. For example, materials, such as JIS SS400 mild steel, AISI 1040 mild steel, aluminum profile 6061, ASTM A283 steel grade D may also be used. Other materials may also be useful, depending on the design requirements.

In one embodiment, a pulley arrangement 960 is mounted onto the frame. The pulley arrangement 960 is different than the arrangement described with respect to FIG. 2 and will be discussed in detail later. The pulley arrangement 960, for example, includes nose pulleys 262 and 264 located at a first end 142 and a tail pulley 272 and a take up pulley 274 located at a second end 144. Additional pulleys, such as bend pulley 978, drive pulley 968 and one or more snub pulleys 977 may also be provided.

A belt 280 is fitted onto the pulley arrangement 960 to form the conveyor surface. The belt, for example, is a conveyor belt which forms a loop. The belt, for example, may include an endless belt, a lace belt or a zip belt. Other types of belts may also be used. The belt includes opposing major surfaces. One of the major surfaces is rough while the other is smooth. Other types of belts may also be used. In one embodiment, the belt is fitted to the pulley arrangement 960 to result in the rough surface to form the conveyor surface. The rough surface is advantageous to provide increased friction with the article to be transported. This avoids or reduces slippage of the article as it is transported by the conveyor.

The drive pulley 968 is coupled to a motor 990 for rotating the drive pulley to cause the conveyor surface to move. In one embodiment, a gear box is used to translate the different drive directions. In one embodiment, the motor is mounted with the axis of rotation of the motor being perpendicular to the axis of rotation of the drive pulley. For example, the motor can be vertically mounted with respect to the conveyor frame. Mounting the motor vertically can facilitate compactness of the junction conveyor. Mounting the motor such that the axis of rotation of the motor is parallel to the axis of rotation to the drive pulley may also be useful. For example, the motor may be mounted horizontally with respect to the conveyor frame. Mounting the motor using other configurations or orientations may also be useful.

In one embodiment, the motor is a three-phase motor, such as an AC gear motor. The motor, for example, is sufficient to move the conveyor surface at about 3.34-3.35 msec or 200-210 m/min. Providing a motor capable of driving the conveyor at other velocities is also useful. Depending on the direction of rotation, the conveyor surface moves in a first or a second direction along the direction of travel, as indicated by arrow 132. In one embodiment, the pulley arrangement 960 results in the rough surface of the belt contacting the surface of the drive pulley 968 and the bend pulley 978. This avoids or reduces slippage of the belt as the drive pulley and bend pulley are rotating, facilitating faster rotations or greater belt velocity. In one embodiment, the motor includes an electrical brake mechanism (not shown) as described previously. Other types of brake mechanisms may also be useful.

The main frame 950, in one embodiment, includes one or more slots for the arrangement of one or more snub pulleys. The one or more slots 942 for the one or more snub pulleys 977, in one embodiment, are located adjacent to the slot 948 for the drive pulley as shown in FIG. 9b. In another embodiment, one slot for the snub pulley is provided adjacent to the drive pulley while another slot of the snub pulley is provided adjacent to the slot 949 for the bend pulley as shown in FIG. 9c. Providing other number of slots for the snub pulleys and providing the slots at other locations of the main frame, depending on the direction of the belt travel are also useful.

In one embodiment, the conveyor frame 950 includes side guards 256. The side guards are mounted to the frame along the direction of travel. The side guards prevent articles on the conveyor surface from falling off the sides of the conveyor. Referring to FIG. 9d, the side guard, in one embodiment, includes a base 256a. The base of the side guard, for example, is made of low friction or light weight materials, such as polymer. For example, the polymer includes ultra high molecular weight polyethylene (UHMWPE) or nylon. Other materials may also be useful. The use of light weight materials is advantageous as it minimizes the gap between the surface of the belt and the side guards. The reduced gap size prevents jamming of articles in the gap during transferring of the articles.

In one embodiment, a cover 947 may be provided at one end of the side guard as shown in FIG. 9a. For example, the cover is provided near the first end 142 of the junction conveyor. The cover, for example, covers a portion of the first nose pulley. Additionally, the cover is configured to fit precisely to the profile of the conveying belt. This reduces the gap between the first end 142 of the junction conveyor with the first side 117 of the first conveyor 110 and prevents jamming of articles.

The junction conveyor, in one embodiment, includes a support structure 957. The support structure, for example, is disposed between the main frame 950 and the frame legs 952. FIG. 9e shows an example of the support structure and its lock position 957a. During normal operation of the junction conveyor, the support structure will be in its lock position. In the event where the junction conveyor requires belt replacement or maintenance, the support structure 957 will be configured at a standing position 957b on the cross brace 954 to support the weight of the main frame 950. As such, maintenance or belt replacement can be conducted easily with the configuration of the support structure as described.

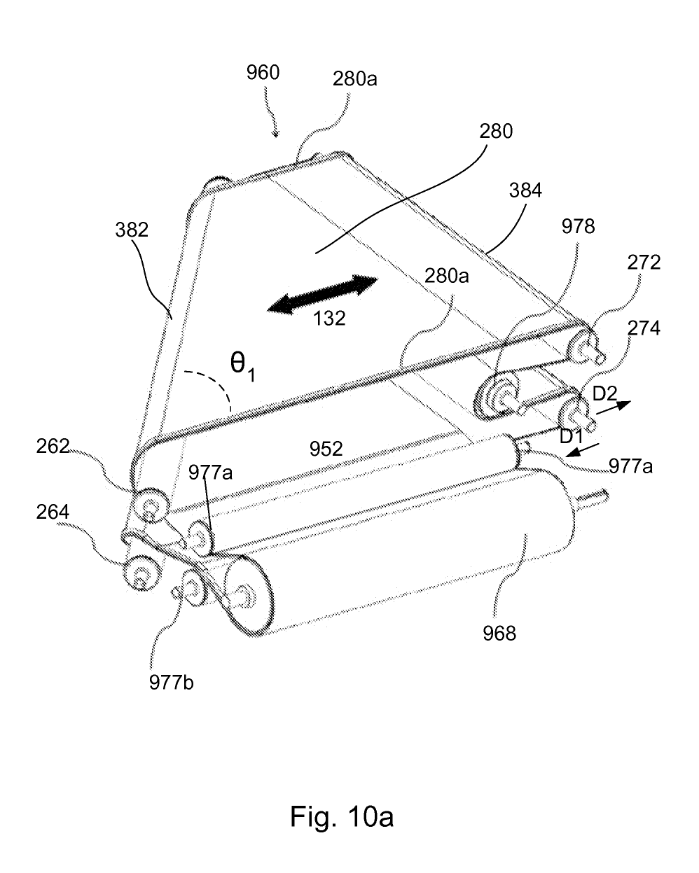

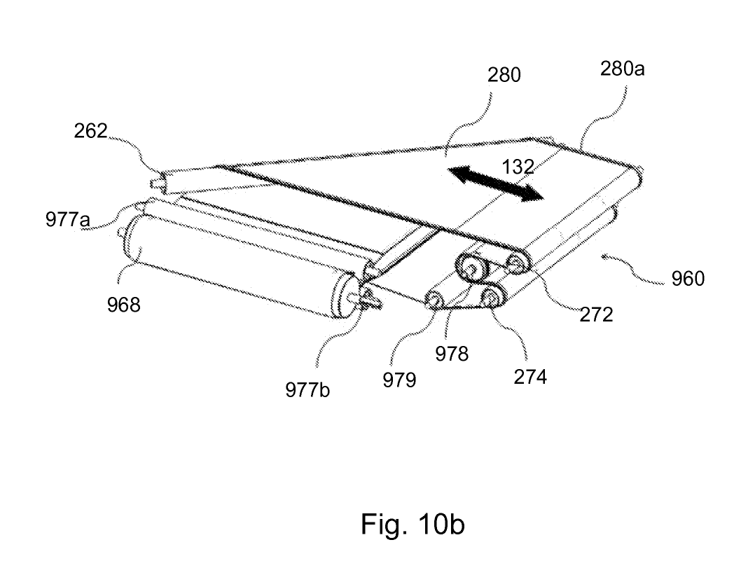

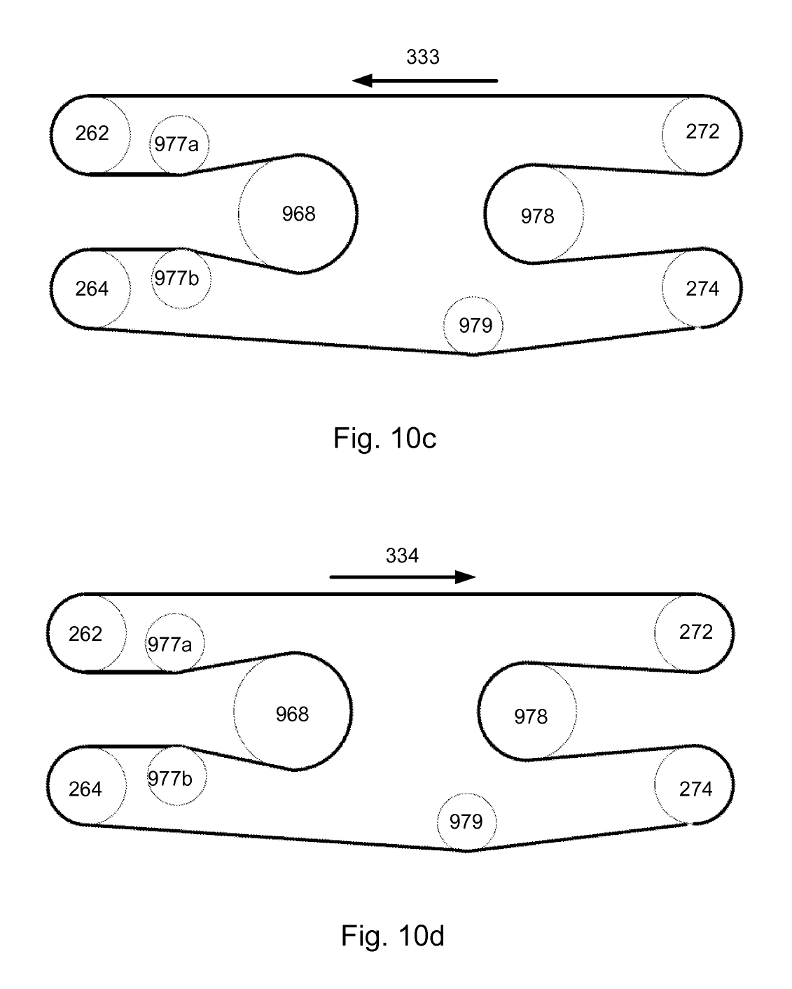

FIGS. 10a-b shows various dimensional views of another embodiment of a pulley arrangement 960 with a belt 280 while FIGS. 10c-d show simplified views of the pulley arrangement with the belt. As shown, the pulley arrangement includes a plurality of pulleys. At a first end 382 of the pulley arrangement, which corresponds to the first or nose end of the junction conveyor, first and second nose pulleys, 262 and 264, are provided. The nose pulleys are disposed at an angle θ₁ with respect to the direction of travel of the belt, as indicated by arrow 132. The angle θ₁, as discussed may range from about 30-60°. In one embodiment, the angle θ₁ is about 45°. Arranging the nose pulleys at other angles may also be useful. The first and second nose pulleys include a length. The length of the nose pulley may vary, depending on the angle θ₁. For example, the length of the nose pulley for 30° with respect to direction of travel may be longer than the length of the nose pulley for 45°. In one embodiment, the length of the nose pulley is at least equal to width of conveyor/sine θ₁. The first nose pulley is disposed above the second nose pulley, forming upper and lower nose pulleys. In one embodiment, the nose pulleys are vertically (or in a direction perpendicular to the plane of the conveyor surface) aligned. Providing other configurations of the nose pulleys may also be useful.

The first and second nose pulleys 262 and 264 in the pulley arrangement 960, in one embodiment, are configured to be operational in three conditions. In one embodiment, the first and second nose pulleys 262 and 264 are configured to be free rolling pulleys. In another embodiment, one of the nose pulleys may be a fixed pulley while the other nose pulley may be free rolling. In yet another embodiment, the nose pulleys are fixed or non-rotating rollers. Such arrangement reduces friction and therefore enables high speed operation with low heat dissipation. Furthermore, increased reliability is achieved. For example, reduced heat generation increases life span of consumable parts of the junction conveyor, such as nose pulleys, belt and motor.

A tail pulley 272 and a take up pulley 274 are disposed on a second end 384 of the pulley arrangement, which corresponds to the branch end of the junction conveyor. In one embodiment, the tail and take up pulley are disposed perpendicularly with respect to the direction of travel. In one embodiment, the tail and take up pulleys are vertically (or in a direction perpendicular to the plane of the conveyor surface) aligned. Providing other configurations of the tail and take up pulleys may also be useful. For example, the take up pulley may be recessed from the edge of the second end of the junction conveyor, as shown in FIG. 10b.

In one embodiment, a bend pulley 978 is disposed perpendicularly with respect to the direction of travel near the second end of the pulley arrangement 960. The bend pulley is located between the tail and take up pulleys and recessed from the second end of the pulley arrangement. The bend pulley, in one embodiment, is located a distance away from the second end to get a belt wrapping angle of at least 200° around it. Such arrangement of the bend pulley reduces belt slippage and provides better efficiency for driving the belt. In addition, such an arrangement of the bend pulley shortens the conveyor length, thereby providing higher throughput. For example, the conveyor length is shortened about 1.1 meter.

A drive pulley 968 is disposed in parallel with respect to the direction of travel from a first end of the pulley arrangement. The drive pulley, for example, is disposed on a side which is longer along the direction of travel and forms an angle θ₁ with respect the nose pulleys. The angle θ₁, as discussed may range from about 30-60°. In one embodiment, the angle θ₁ is about 45°. Arranging the drive pulley at other angles with respect to the nose pulleys may also be useful. As shown, a first end of the drive pulley is adjacent to first ends of the nose pulleys. A second end of the drive pulley is distal from the first ends of the nose pulleys. In one embodiment, the drive pulley is located between the nose pulleys. A motor is coupled to the drive pulley. The motor, for example, can be horizontally or vertically coupled to the drive pulley. When the motor rotates the drive pulley, the conveyor surface moves. For example, the conveyor surface moves in a first direction, as indicated by arrow 333 when the drive pulley rotates in a clockwise direction. When the drive motor rotates in a counter-clockwise direction, the conveyor surface moves in a second direction, as indicated by arrow 334. The arrangement of the drive and bend pulleys as described above may include some or all the advantages of the arrangement of the drive and bend pulleys, as discussed with respect to FIGS. 3a-d.

In one embodiment, the pulley arrangement 960 includes one or more snub pulleys 977. The one or more snub pulleys, for example, are adjustable snub pulleys. For example, the snub pulleys can be adjustable horizontally for belt tracking. In one embodiment, the one or more snub pulleys are provided adjacent to the drive pulley. For example, a first snub pulley 977a is provided between the first nose pulley 262 and the drive pulley and a second snub pulley is provided between the drive pulley and the second nose pulley 264. The first and second snub pulleys are adjustable to provide better drive efficiency by getting a belt wrapping angle of at least 200° around the drive pulley. Providing the snub pulleys at other locations of the pulley arrangement may also be useful.

Referring to FIGS. 10a-d, the upper nose pulley and tail pulley form an upper pulley level of the pulley arrangement 960 and defines the conveying. The lower nose pulley and take up pulley form a lower pulley level of the pulley arrangement. The bend pulley and drive pulley are disposed in an intermediate pulley level between the upper and lower pulley levels. An additional snub pulley 979 is disposed over the surface of the belt below the lower pulley level. As shown, the axes of rotation of the pulleys within a pulley level form parallel planes. Providing pulleys of different pulley levels which do not form parallel planes may also be useful.

The pulleys in the pulley arrangement 960 may have the same and/or different diameters. In one embodiment, the take up, tail and nose pulleys have the same drum diameter while the drive pulley has a larger diameter. The one or more snub pulleys may have a diameter which is smaller than the nose and other pulleys. Other arrangements of pulley diameters may also be useful. The diameter of the drive pulley may be selected based on the desired speed of the junction conveyor or other design requirements.

The belt fits around the pulleys of the pulley arrangement to form a continuous loop. For example, the belt fits around the upper nose pulley, drive pulley, lower nose pulley, take up pulley, bend pulley, tail pulley and back to the upper nose pulley. The take up pulley adjusts the tension of the belt around the pulleys. For example, the take up pulley can be adjusted horizontally, such as in the direction of D1 or D2, as shown in FIG. 10a, to loosen or tighten the belt. The bend pulley is adjustable for belt to be square during installation. Similar to the take up pulley, the bend pulley, for example, can be adjusted horizontally to counter the forces to ensure that the belt is tracked properly during operation. The snub pulleys are adjustable for alignment of the belt and further provide a bigger belt wrapping angle over the drive pulley to increase drive efficiency as discussed above. The lengths of the pulley should be sufficient to accommodate the width of the belts.

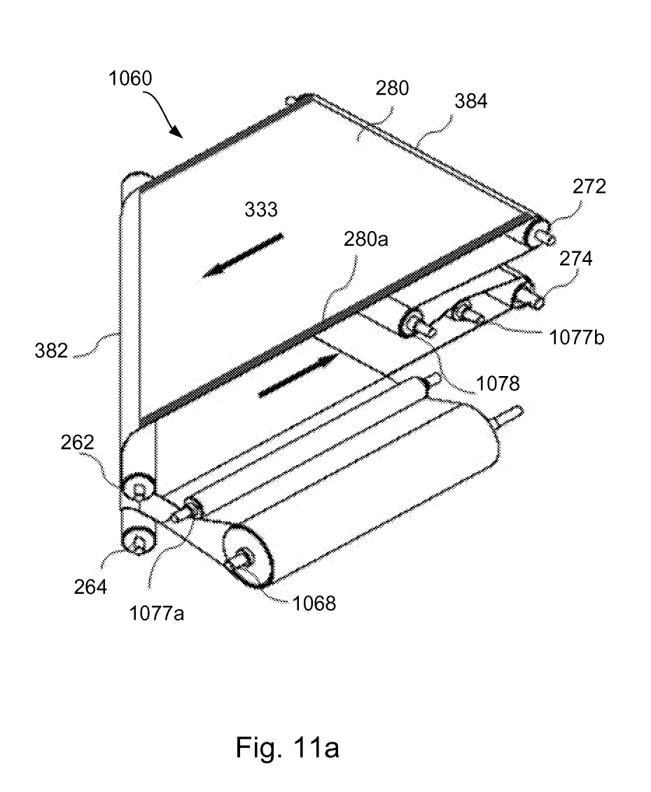

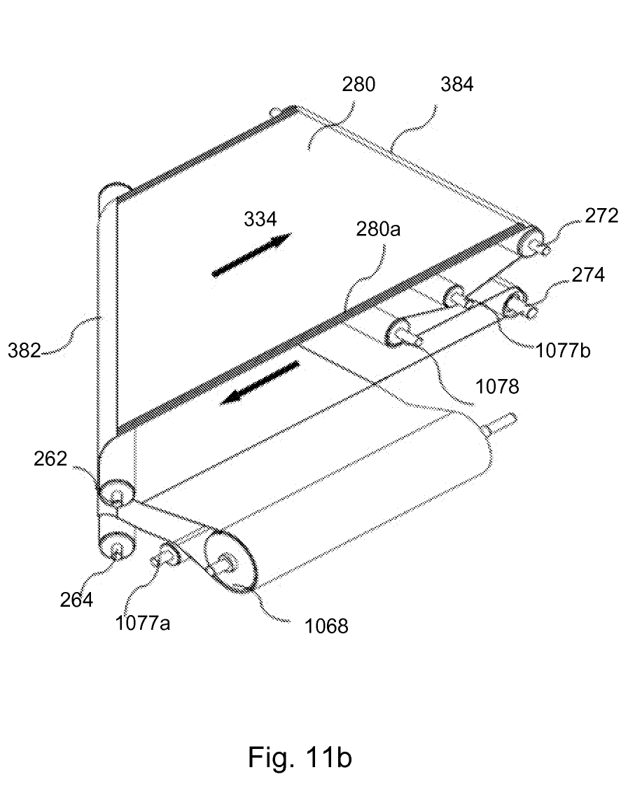

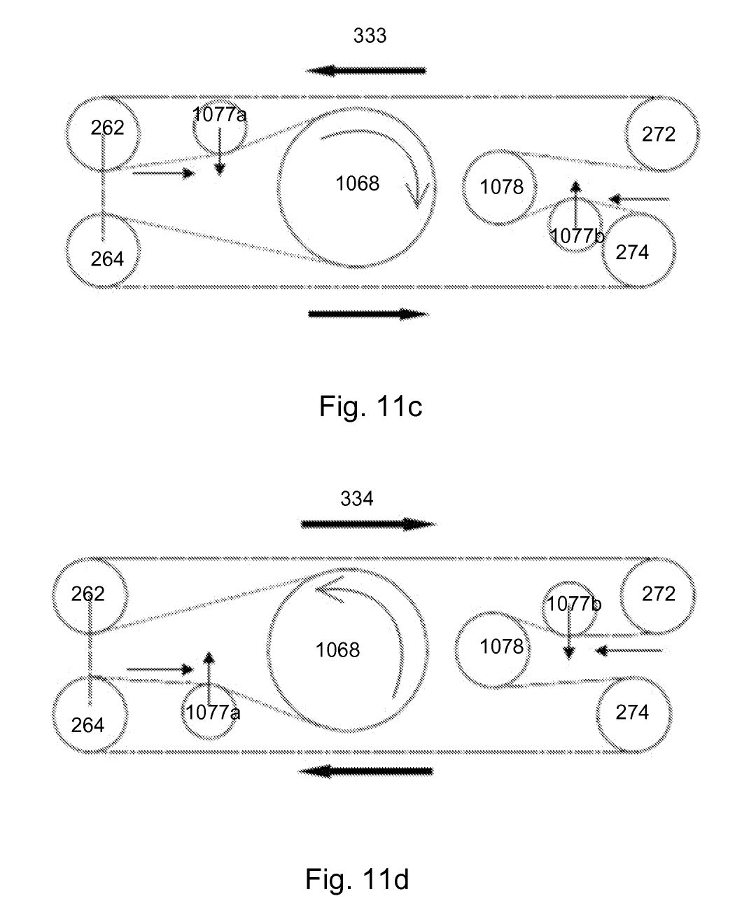

FIGS. 11a-b show various dimensional views of yet another embodiment of a pulley arrangement 1060 with a belt 280 while FIGS. 11c-d show simplified views of the pulley arrangement 1060 with the belt. The pulley arrangement 1060, for example, is similar to that described in FIGS. 10a-d except the arrangement of the one or more snub pulleys. As such, the common features need not be discussed.

Referring to FIGS. 11a-d, the upper nose pulley and tail pulley form an upper pulley level of the pulley arrangement 1060 and defines the conveying. The lower nose pulley and take up pulley form a lower pulley level of the pulley arrangement. The bend pulley and drive pulley are disposed in an intermediate pulley level between the upper and lower pulley levels. As shown, the axes of rotation of the pulleys within a pulley level form parallel planes. Providing pulleys of different pulley levels which do not form parallel planes may also be useful.

The pulley arrangement 1060, in one embodiment, includes one or more snub pulleys 1077. The one or more snub pulleys, for example, are adjustable snub pulleys. For example, the snub pulleys can be adjustable horizontally for belt tracking. In one embodiment, a first snub pulley 1077a is provided adjacent to the drive pulley 1068 and a second snub pulley 1077b is provided adjacent to the bend pulley 1078. The first and second snub pulleys provide counter force for belt alignment. For example, the first snub pulley 1077a is placed beyond the rotational force of the drive pulley, whereas the second snub pulley is placed beyond the rotational movement or bending movement of the bend pulley. As a result, these counter forces derives from the snub pulleys provides equilibrium for center alignment of the belt. Providing the snub pulleys at other locations of the pulley arrangement may also be useful.

The belt fits around the pulleys of the pulley arrangement 1060 to form a continuous loop. For example, the belt fits around the upper nose pulley, drive pulley, lower nose pulley, take up pulley, bend pulley, tail pulley and back to the upper nose pulley.

In one embodiment, the belt comprises a rough surface and a smooth surface. The arrangement of pulleys should result in the rough surface of the belt forming the conveying surface between the top nose pulley and tail pulley as well as contacting the surface of the drive pulley. This reduces slippage of the articles from the conveying surface and also provides a better driving efficiency. In one embodiment, the pulley arrangement should result in the smooth surface of the belt contacting the surface of the nose pulleys, tail pulley and take up pulley. This advantageously reduces heat generation and increases efficiency.

To facilitate side alignment of the belt, the belt may optionally include a belt guide having a belt fitting surface such as a protrusion and one or more pulleys may optionally include a pulley guide having a pulley fitting surface such as a step profile. For example, the protrusion of the belt and the step profile of one or more pulleys are used in the pulley arrangement of 960 and 1060 as described with respect to FIGS. 10a-d and FIGS. 11a-d. Providing a belt with a belt fitting surface and pulleys with pulley fitting surface for the pulley arrangement of 360 as described with respect to FIGS. 3a-d may also be useful.

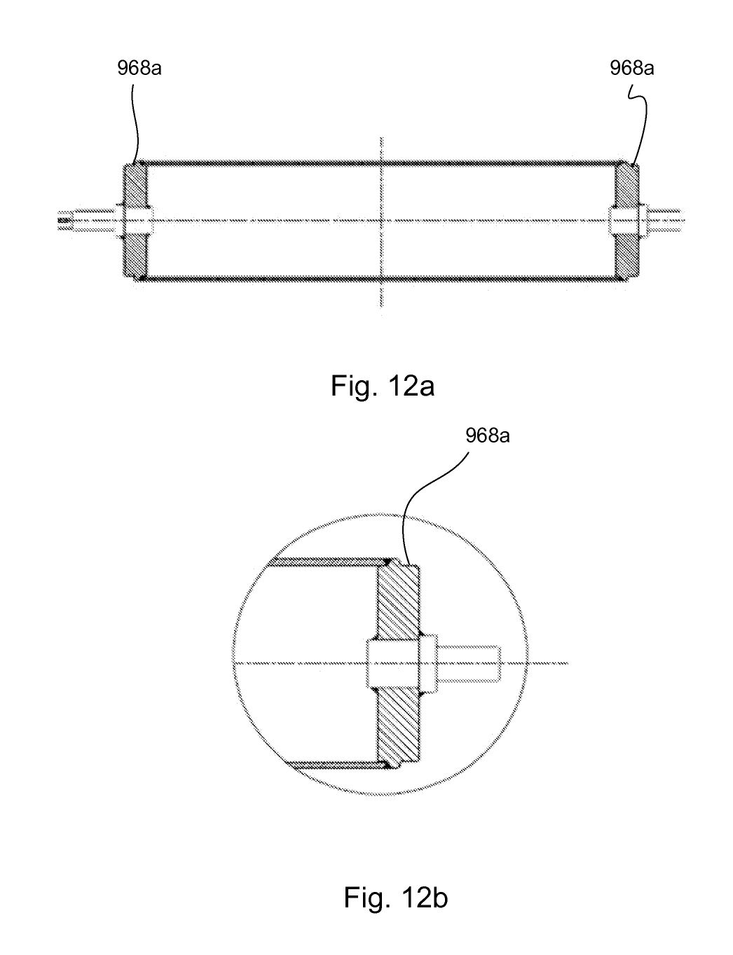

As discussed, one or more pulleys may include pulley fitting surfaces 968a. For example, the pulley fitting surface includes a step profile. In one embodiment, the drive pulley includes a step profile at both ends of the drive pulley as shown in FIGS. 12a-b. The bend pulley, in one embodiment, may also include the step profile at its ends. The pulley fitting surface can be of any shape, such as rectangular, square, etc., depending on the shape of the fitting surface of the belt. Providing the pulley fitting surface with other profiles and providing a step profile for other pulleys may also be useful. The step profile, for example, includes a smooth surface at the corner of the step profile. This smooth surface reduces or prevents the belt from tearing. In another embodiment, the pulley fitting surface comprises one or more receptacles for receiving a belt fitting surface from the belt. The pulley fitting surface such as receptacles, for example, is provided a distance away from both ends of the drive pulley or the bend pulley. For example, the pulley fitting surface is provided at about 18-20 mm away from the ends of the drive pulley or bend pulley. Providing the pulley fitting surface at other location of the pulleys may also be useful.

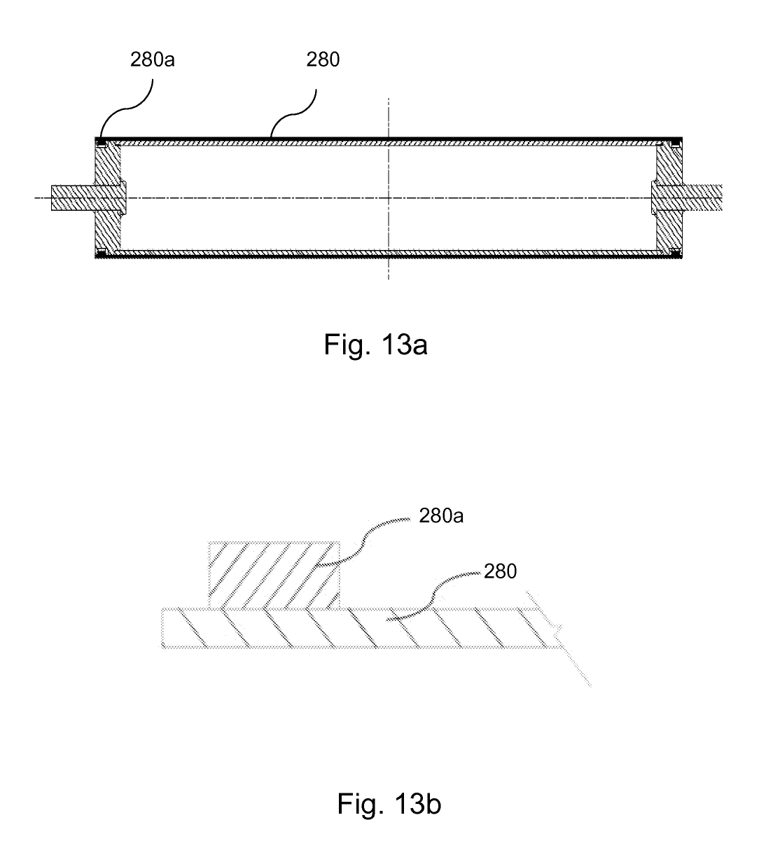

The belt, in one embodiment, includes a belt fitting surface 280a. For example, the belt fitting surface includes a protrusion as shown in FIGS. 13b. The protrusion of the belt can be of any shape, such as rectangular, square, etc., depending on the shape of the fitting surface of the pulley. Providing the belt fitting surface with other shapes may also be useful. The protrusion, in one embodiment, is made of materials such as polymer. Other types of materials may also be useful. The belt fitting surface and the pulley fitting surface, when coupled, are mated to each other such that the side of the belt is aligned as shown in FIG. 13a. This prevents the belt from sliding to the edge of the conveyor.

To facilitate tracking and centering of the belt, the pulleys such as the tail and take up pulleys of the pulley arrangement 960 or 1060, in one embodiment, comprise crown pulleys. A crown pulley is a pulley whose diameter is the greatest at a center and tapers to a smallest diameter at the ends as previously described with respect to FIG. 4. In one embodiment, the nose pulleys of the pulley arrangement 960 or 1060 comprise non-tapered pulleys. Providing the nose pulleys of the pulley arrangement 960 or 1060 with tapered pulleys as described in FIG. 5 may also be useful.

As discussed, the first and second nose pulleys 262 and 264 in the pulley arrangement 960 or 1060, in one embodiment, are configured to be operational in three conditions. In one embodiment, the first and second nose pulleys 262 and 264 are configured to be free rolling pulleys. In another embodiment, one of the nose pulleys may be a fixed pulley while the other nose pulley may be free rolling. In yet another embodiment, the nose pulleys are fixed or non-rotating rollers.

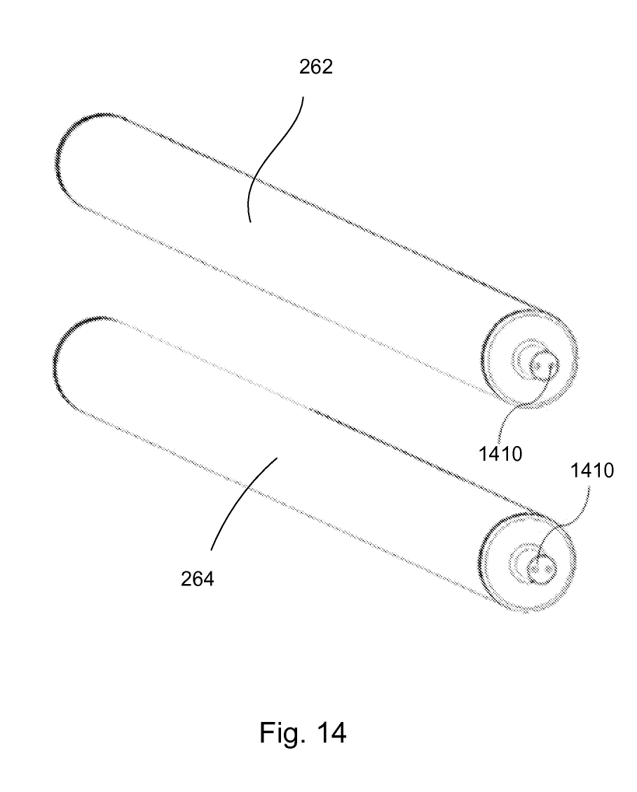

For configurations which include one or more fixed nose pulleys, the nose pulley may include one or more fastener openings 1410 at the shaft of the nose pulleys as shown in FIG. 14. The fastener openings are provided at both ends of the shaft. Referring to FIG. 14, the nose pulley, for example, includes 2 fastener openings at each end of the nose pulley. Providing other numbers of fastener openings may also be useful.

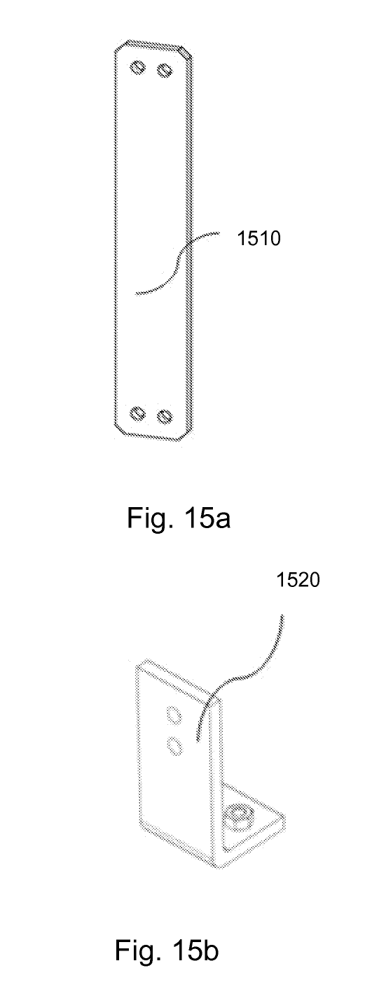

A stop plate is provided, allowing one or more of the nose pulleys to be fixed to the main frame. In one embodiment, the stop plate includes an I-shaped stop plate 1510. Referring to FIG. 15a, the I-shape stop plate, for example, includes one or more fastener openings which match the fastener openings of the shaft of the nose pulley. The I-shaped stop plate enables both the nose pulleys to be fixed to the main frame by one or more fasteners such as screws. Other types of fasteners are also useful. In another embodiment, the stop plate includes an L-shaped stop plate 1520 as shown in FIG. 15b. Similar to the I-shaped stop plate, the L-shape stop plate also includes one or more fastener openings which match the fastener openings of the shaft of the nose pulley. The L-shaped stop plate enables one of the nose pulleys to be fixed to the main frame while allowing the other nose pulley to freely rotate. Providing a stop plate with other shapes may also be useful.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A junction conveyor comprising:
a conveyor frame;
a pulley arrangement having a plurality of pulleys being mounted onto the frame, wherein the pulley arrangement comprises
at least a first and a second end pulley defining a first and a second end of the junction conveyor,
at least one of the pulleys includes a free rolling pulley, and
a drive pulley for driving a belt to cause a junction conveyor surface to move in a desired direction; and
a belt being fitted to the pulley arrangement to form a junction conveyor surface.

2. The junction conveyor of claim 1 wherein the first end pulley is a first nose pulley and the second end pulley is a tail pulley.

3. The junction conveyor of claim 2 wherein the pulley arrangement further includes a second nose pulley located at the first end and a take up pulley at the second end of the junction conveyor.

4. The junction conveyor of claim 3 wherein the first nose pulley is disposed above the second nose pulley and the nose pulleys are disposed at an angle θ₁ with respect to a direction of travel of the belt.

5. The junction conveyor of claim 4 wherein θ₁ ranges from about 30 to 60°.

6. The junction conveyor of claim 4 wherein:
the tail, take up and drive pulleys are disposed perpendicularly with respect to the direction of travel of the belt; and
the drive pulley is disposed between the tail and take up pulleys and is located a distance away from the second end.

7. The junction conveyor of claim 6 further includes a bend pulley, wherein:
the bend pulley is disposed in parallel with respect to the direction of travel of the belt from the first end and is disposed between the first and second nose pulleys; and
the bend pulley is configured to be adjustable horizontally.

8. The junction conveyor of claim 7 wherein:
the first nose pulley and tail pulley form an upper pulley level;
the second nose pulley and take up pulley form a lower pulley level; and
the bend and drive pulleys form an intermediary pulley level, wherein axes of rotation of the bend pulley and the drive pulley forms a plane such that the pulleys at the upper pulley level and the pulleys at the lower pulley level are arranged substantially symmetrical with respect to the plane.

9. The junction conveyor of claim 7 wherein the bend pulley or the take up pulley comprises a crown pulley.

10. The junction conveyor of claim 4 further includes a bend pulley, wherein:
the tail, take up and bend pulleys are disposed perpendicularly with respect to the direction of travel of the belt; and
the bend pulley is disposed between the tail and take up pulleys and is located a distance away from the second end.

11. The junction conveyor of claim 10 wherein the drive pulley is disposed in parallel with respect to the direction of travel of the belt from the first end and is disposed between the first and second nose pulleys.

12. The junction conveyor of claim 11 further includes at least one snub pulley.

13. The junction conveyor of claim 3 wherein the first and second nose pulleys are free rolling pulleys.

14. The junction conveyor of claim 10 wherein the first and second nose pulleys comprise tapered pulleys.

15. The junction conveyor of claim 3 wherein the second nose pulley is a free rolling pulley.

16. The junction conveyor of claim 2 wherein the first nose pulley is a free rolling pulley.

17. The junction conveyor of claim 1 wherein the belt includes a smooth and a rough major surface.

18. The junction conveyor of claim 8 wherein the rough surface of the belt contacts a surface of the drive pulley.

19. The junction conveyor of claim 1 further comprises a motor to drive the drive pulley, wherein the motor includes an electrical brake mechanism.

20. A conveyor system comprising:
a first and a second conveyor; and
a junction conveyor, wherein the junction conveyor includes
a conveyor frame,
a pulley arrangement having a plurality of pulleys being mounted onto the frame, wherein the pulley arrangement comprises
at least a first and a second end pulley defining a first and a second end of the junction conveyor,
at least one of the pulleys includes a free rolling pulley, and
a drive pulley for driving a belt to cause a junction conveyor surface to move in a desired direction, and
a belt being fitted to the pulley arrangement to form a junction conveyor surface,
wherein the junction conveyor is disposed between the first and second conveyors and the first conveyor is disposed at an angle θ₁ with respect to the second conveyor.
